(19) United States
(12) Patent Application Publication
(10) Pub. No.: US 2021/0164488 A1
(43) Pub. Date: Jun. 3, 2021

(54) Radial Compressor Impeller

(71) Applicant: MAN Energy Solutions SE, Augsburg (DE)

(72) Inventors: Jirí KLIMA, Namest nad Oslavou (CZ); Klaus BEHNKE, Schriesheim (DE)

(73) Assignee: MAN Energy Solutions SE

(21) Appl. No.: 17/109,285

(22) Filed: Dec. 2, 2020

(30) Foreign Application Priority Data
Dec. 3, 2019 (DE) 10 2019 132 861.6

(51) Int. Cl. F04D 29/28; F04D 29/02

(52) U.S. Cl. CPC F04D 29/284; F05D 2300/125; F05D 2300/121; F04D 29/023

(57) ABSTRACT

A radial compressor impeller, having a hub-like main body, whose flow-guiding surface has a contour that increases in size in the radial direction from a flow inlet end in the direction of a flow outlet end, moving blades arranged on the hub-like main body, namely first moving blades and second moving blades. The first moving blades are formed longer than the second moving blades. Between each two adjacent first moving blades a second moving blade each is arranged. Third moving blades, which are formed shorter than the second moving blades are arranged between each adjacent first and second moving blade.

### BACKGROUND OF INVENTION

### 1. Field of the Invention

The invention relates to a radial compressor impeller.

### 2. Description of Related Art

DE 10 2012 207 727 B4 discloses a radial compressor impeller having a hub-like main body and moving blades arranged on the hub-like main body. The hub-like main body provides a flow-guiding surface of the compressor impeller that increases in size from a flow inlet end of the radial compressor impeller in the direction of a flow outlet end of the radial compressor impeller in the radial direction. On the hub-like main body, first moving blades and second moving blades are arranged, wherein the first moving blades, seen in the axial direction and in the radial direction, are formed longer than the second moving blades, and wherein between each two adjacent first moving blades a second moving blade each is arranged. The first moving blades are also referred to as so-called main blades and the second moving blades also as so-called splitter blades.

### SUMMARY OF THE INVENTION

During operation, the radial compressor impeller may heat up. There is a need for restricting the heating-up of the radial compressor impeller. There is also a need for improving aerodynamic characteristics of the radial compressor impeller, i.e. the flow guiding characteristics of the same.

Starting out from this, one aspect of the invention is based on creating a new type of radial compressor impeller.

The radial compressor impeller according to one aspect of the invention comprises third moving blades that are designed shorter than the second moving blades, wherein between each adjacent first and second moving blades a third moving blade each is arranged.

With the third moving blades, which in the axial direction and in the radial direction are formed shorter than the second moving blades, heat can be passed on to the flow to be guided by the radial compressor impeller in the region of the flow outlet end of the radial compressor impeller. By way of this, a heating-up of the radial compressor impeller during the operation can be limited.

Furthermore, aerodynamic characteristic of the radial compressor impeller in particular in a part load operation can be improved via the third moving blades with a view to an improved flow guidance in a region of the flow outlet end.

According to an advantageous further development, flow leading edges of the second moving blades, seen in the flow direction, are arranged downstream of flow leading edges of the first moving blades, wherein flow leading edges of the third moving blades, seen in the flow direction, are arranged downstream of the flow leading edges of the second moving blades.

According to an advantageous further development, the flow outlet end of the hub-like main body has an outlet radius, wherein the flow leading edges of the third moving blade are arranged in a range between 60% and 85% of the outlet radius. Flow trailing edges of the third moving blade are preferentially arranged in a range between 90% and 100% of the outlet radius.

In particular when the third moving blades, based on the outlet radius of the radial compressor impeller, are positioned in the range defined above, heat from the radial compressor impeller can be particularly advantageously passed on to the flow to be guided in the region of the flow outlet end of the radial compressor impeller. In the part load range of the radial compressor impeller, a particularly advantageous flow guidance is then possible.

According to an advantageous further development, the radial compressor impeller consists of an aluminium alloy or a magnesium alloy. One aspect of the invention is particularly advantageously employed with radial compressor impellers that are formed of an aluminium alloy or a magnesium alloy.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1 is a perspective front view of a radial compressor impeller;

FIG. 2 is a perspective back view of the radial compressor;

FIG. 3 is a front view of the radial compressor impeller; and

FIG. 4 is a lateral view of the radial compressor impeller.

### DETAILED DESCRIPTION OF THE PRESENTLY PREFERRED EMBODIMENTS

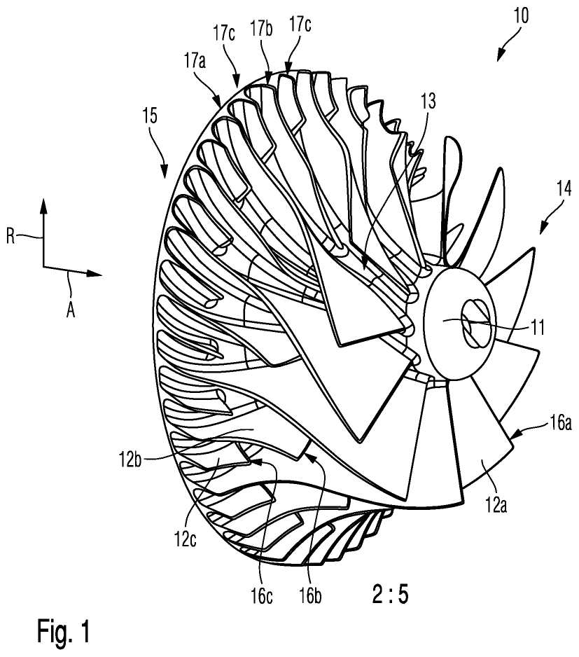

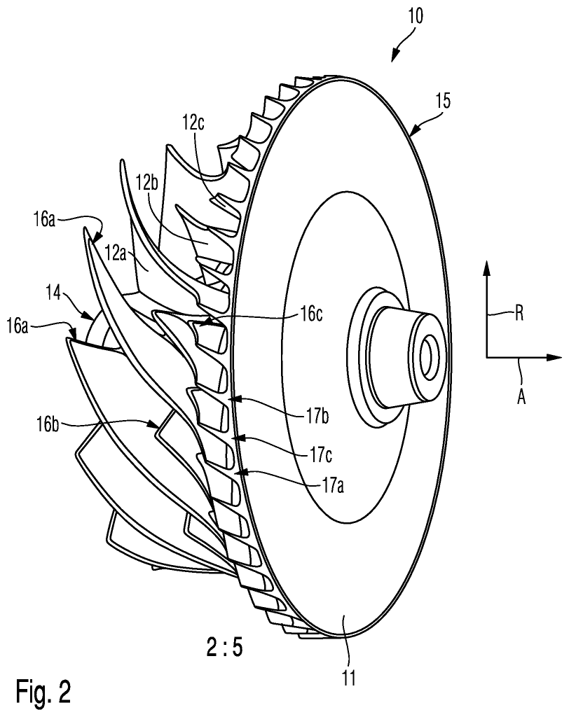

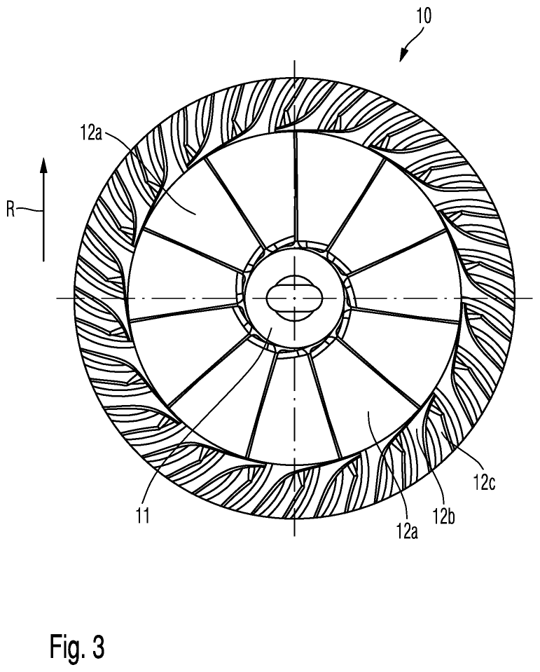

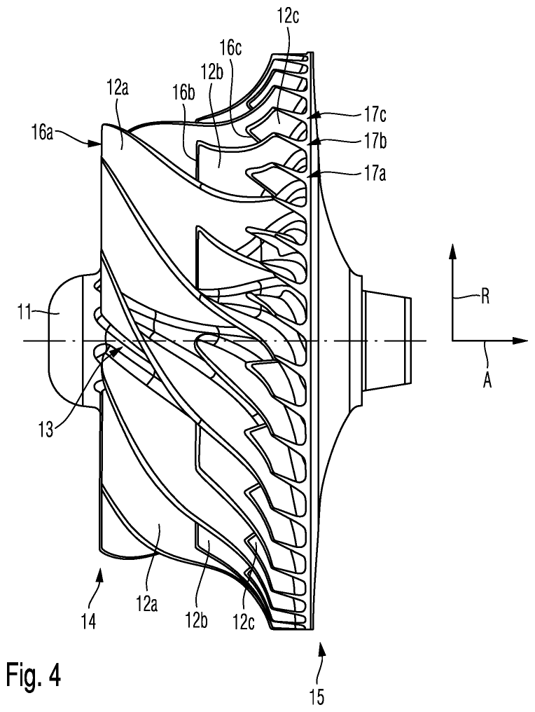

FIGS. 1 to 4 show different views of a radial compressor impeller 10, wherein the radial compressor impeller 10 has a hub-like main body 11 and multiple moving blades 12 arranged on the hub-like main body 11.

The hub-like main body 12 provides a flow-guiding surface 13 for the radial compressor impeller 10, which increases in size from a flow inlet end 14 in the direction of a flow outlet end 15 of the radial compressor impeller 10 in the radial direction R. On this flow-guiding surface 13, the moving blades 12 are formed, which originating from this flow-guiding surface 13 extend away in the radial direction R and in the axial direction A. These moving blades 12 are curved in the circumferential direction and provide further flow-guiding surfaces of the radial compressor impeller 10.

On the hub-like main body 11, different moving blades 12 are formed, namely first moving blades 12a, second moving blades 12b and third moving blades 12c.

The first moving blades 12a are formed longer, seen in the axial direction A and/or in the radial direction R, than the second moving blades 12b. Between each two adjacent first moving blades 12a, a second moving blade 12b each is arranged.

Seen it the axial direction A and/or in the radial direction R, the third moving blades 12c are formed shorter than the second moving blades 12b. Between each adjacent first and second moving blades 12a, 12b, a third moving blade 12c is arranged.

According to one aspect of the invention, the radial compressor impeller 10 accordingly comprises three different types of moving blades 12a, 12b, and 12c. Basically, the first moving blades 12a and the second moving blades 12b are known from the prior art. The third moving blades 12c are additionally employed which, seen in the radial direction and in the axial direction, each have the shortest extension of the three different moving blade types 12a, 12b, and 12c.

The third moving blades 12c are arranged adjacent to the flow outlet end 15 of the radial compressor impeller 10.

The third moving blades 12c on the one hand assume a cooling function to pass heat from the radial compressor impeller 10 to the flow to be guided and compressed by the same, in the region of the flow outlet end 15. On the other hand, the third moving blades 12c assume a flow guiding function which, in particular in the part load operation, is advantageous in order to provide in the part load operation an improved flow guidance and accordingly improved aerodynamic characteristics of the radial compressor impeller 10.

Each of the moving blades 12a, 12b, and 12c comprises a flow leading edge 16a, 16b, 16c and a flow trailing edge 17a, 17b, 17c.

The flow leading edges 16b of the second moving blades 12b are arranged, seen in the axial direction and in the flow direction, downstream of the flow leading edges 16a of the first moving blades 12a. The flow leading edges 16c of the third moving blades 12c are arranged, seen in the axial direction and in the flow direction, downstream of the flow leading edges 16b of the second moving blades 12b.

In the shown exemplary embodiment, all flow trailing edges 17a, 17b, and 17c of all moving blades 12a, 12b, and 12c are arranged, seen in the radial direction and in the flow direction, in the same position. It is also possible that the flow trailing edges 17c of the third moving blades 12c are arranged, seen in the radial direction and in the flow direction, upstream of the flow trailing edges 17a, 17b of the first and second moving blades 12a, 12c.

The flow trailing end 15 of the hub-like main body 11 and thus of the radial compressor impeller 10 is characterized by an outlet radius. The flow leading edges 16c of the third moving blades 12c are arranged in a range between 60% and 85% of this outlet radius. The flow trailing edges 17c of the third moving blades 12c are arranged in a range between 90% and 100% of this outlet radius.

Accordingly, the third moving blades 12c extend in a range between 60% and 100%, in particular in a range between 85% and 100% or in a range between 60% and 90% or also in a range between 85% and 90% of this outlet radius.

As already explained, heat can be optimally passed on with the third moving blades 12c from the radial compressor impeller 10 to the flow to be compressed.

In particular, the radial compressor impeller 10 including the moving blades 12a, 12b, 12c is manufactured from an aluminium alloy or from a magnesium alloy.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A radial compressor impeller, comprising:
a hub-like main body, having a flow-guiding surface that has a contour that increases in size from a flow inlet end towards a flow outlet end in a radial direction;
first moving blades arranged on the hub-like main body;
second moving blades between each two adjacent first moving blades and arranged on the hub-like main body, wherein the first moving blades are formed longer than the second moving blades; and
third moving blades which are formed shorter than the second moving blades and arranged between each adjacent first and second moving blades.

2. The radial compressor impeller according to claim 1, wherein the third moving blades are arranged adjacent to the flow outlet end.

3. The radial compressor impeller according to claim 1, wherein
flow leading edges of the second moving blades, seen in an axial direction and in a flow direction, are arranged downstream of flow leading edges of the first moving blades, and
flow leading edges of the third moving blades, seen in the axial direction and in the flow direction, are arranged downstream of the flow leading edges of the second moving blades.

4. The radial compressor impeller according to claim 3, wherein
the flow outlet end of the hub-like main body comprises an outlet radius, and
the flow leading edges of the third moving blades are arranged in a range between 60% and 85% of the outlet radius.

5. The radial compressor impeller according to claim 4, wherein
flow trailing edges of the third moving blades are arranged in a range between 90% and 100% of the outlet radius.

6. The radial compressor impeller according to claim 5, wherein the flow trailing edges of the third moving blades, seen in the radial direction and in the flow direction, are arranged in a same position as respective flow trailing edges of the first moving blades and the second moving blades.

7. The radial compressor impeller according to claim 5, wherein the flow trailing edges of the third moving blades, seen in the radial direction and in the flow direction, are arranged upstream of flow trailing edges of the first moving blades and the second moving blades.

8. The radial compressor impeller according to claim 1, wherein the radial compressor impeller comprises an aluminium alloy.

9. The radial compressor impeller according to claim 1, wherein the radial compressor impeller comprises a magnesium alloy.
